(19) United States
(12) Patent Application Publication
(10) Pub. No.: US 2026/0369633 A1
(43) Pub. Date: Nov. 19, 2026

(54) AN ENERGY GENERATION SYSTEM WITH A CATALYTIC BURNER

(71) Applicant: NAPOP AS, Vikersund (NO)

(72) Inventors: Aage Bjørn Andersen, Vikersund (NO); Terje Paulsen, Vikersund (NO)

(73) Assignee: NAPOP AS, Vikersund (NO)

(21) Appl. No.: 19/137,631

(22) PCT Filed: Dec. 21, 2023
(86) PCT No.: PCT/EP2023/087190

§ 371 Date: Jun. 10, 2025

(30) Foreign Application Priority Data
Dec. 22, 2022 (GB) 2219543.2

(51) Int. Cl. H01M 8/04014; F23C 13/02; H01M 16/00

(52) U.S. Cl. CPC H01M 8/04022; F23C 13/02; H01M 16/006; F23C 2900/03009

(57) ABSTRACT

An energy generation system (1) comprises: a catalytic burner (40) for producing heat energy; an insulated vessel (32), wherein the insulated vessel (32) surrounds the catalytic burner (40); and a fuel cell, wherein waste heat from the fuel cell can be provided to the catalytic burner (40) and/or to the insulated vessel (32); wherein the catalytic burner (40) includes a catalytic coil comprising a coil-shaped fluid flow path for flow of a fuel mixture and a catalytic surface extending along at least a part of the coil-shaped fluid flow path.

The present invention relates to an energy generation system comprising a catalytic burner for generating heat. In some implementations a fuel cell is also included for generating electricity. The present invention further relates to a method of generating energy (i.e. heat and/or electrical energy) using the energy generation system.

Generation of heat using catalytic combustion of fuel is an alternative to traditional combustion of fuels. In traditional combustion of fuels, a fuel mixture is ignited in air to generate heat via an exothermic reaction. The elevated temperatures of traditional combustion, as well as different compositions of the fuel mixtures, can result in undesirable combustion products. For example, high temperatures (e.g. above 1300 °C) of traditional combustion, combined with a fuel mixture comprising nitrogen (N) such as air, can result in the formation of nitrogen oxide species (e.g. NOₓ), which are undesirable. Other combustion conditions can lead to the formation of carbon monoxide (CO), for example when fossil fuels or hydrocarbons (e.g. CₓH_{y}) are combusted in an oxygen poor atmosphere. This formation of carbon monoxide is undesirable partly due to the health hazards of carbon monoxide. Furthermore, traditional combustion requires certain conditions to sustain it. For example, providing a fuel mixture with a wrong ratio of components can result in termination of the combustion. Alternatively, providing a fuel mixture too rapidly (e.g. at too high speed) can result in the flame blowing out, likewise terminating combustion.

Catalytic combustion of a fuel mixture relies on a principle of using a catalyst material to allow a chemical reaction (i.e. an oxidation reaction) to proceed at lowered thermo-chemical conditions. In general, catalysts can be used to promote chemical reactions at lower temperatures, lower pressures and/or lower electro-chemical potentials etc. That is, the use of a catalyst material in a reaction, lowers the activation energy necessary for the chemical reaction to take place. Viewed from one angle, catalytic combustion results in a chemical reaction between fuel components at lower temperatures. Viewed from another angle, catalytic combustion results in a faster chemical reaction between fuel components at a particular temperature. An example of a catalytic combustion is the combination of a catalyst, natural gas and oxygen in a catalytic heater to produce heat. The catalytic reaction is sometimes termed flameless because it proceeds at a low enough temperature that does not result in a flame. Spontaneous hydrogen combustion in air occurs at around 500 °C Providing a suitable catalyst can lower this combustion temperature.

A fuel cell is a device which converts chemical energy of a fuel into electrical energy. A typical fuel cell uses an anode, a cathode and an electrolyte in between the anode and the cathode. A fuel mixture is introduced to the anode, resulting in a charged particle diffusing through the electrolyte to the cathode. At the cathode, the charged particle combines with another specie to form reaction products. Concurrently, an electric charge in the form of electrons travels from the anode, through a circuit, to the cathode, participating in the above combination. The movement of the electrons through the circuit results in the generation of electric energy (i.e. electricity). An exemplary fuel cell uses hydrogen (H₂) and oxygen (O₂) as fuel sources, providing the hydrogen gas to the anode and providing the oxygen gas (often using air as carrier) to the cathode. The fuel cell reaction results in the formation of water (H₂O) either as vapour or liquid, as well as the generation of heat. In conventional fuel cell setups, the heat generated by the fuel cell is dissipated into the environment to avoid undesirable heat accumulation in the fuel cell.

Fuel cells are now increasingly adopted in the field of industrial electricity generation. For example, on constructions sites which are not connected to a power grid, electricity demand for construction equipment can be satisfied by the provision of a fuel cell. Furthermore, an increased pressure for lowering the carbon footprint of private individuals, companies and nations have made the use of fuel cells more desirable. This is because the fuel used by the fuel cell (e.g. hydrogen and oxygen) can be produced by carbon-zero methods. Therefore, the use of fuel cells and hydrogen fuels is advantageous in terms of reducing the carbon footprint of activities. Additionally, a fuel cell does not result in undesirable and/or harmful emissions, which makes them even more attractive from an environmental point of view. However, as discussed above, some of the energy generated by a fuel cell in the form of heat is typically lost. There is therefore a need to develop more efficient systems for energy generation.

As discussed above, fuel cells can be used in a construction setting, where electricity generation is needed. In some cases, the construction setting may also require large quantities of heat for construction activities such as drying, heating, hardening or thawing. Typically, where electricity is readily available, electric heaters are used to generate heat, however, the use of such electric heaters is sometimes unfavourable. Where electricity is not readily available (e.g. remote settings) burner heaters are used, which commonly burn fossil fuels to generate heat. However, as discussed above, the combustion of fossil fuels results in undesirable pollutants being released to the atmosphere. Additionally, burning fossil fuels results in carbon dioxide (CO₂) emissions, which makes this method not carbon-zero/carbon-neutral. There is therefore a need to provide a better heat source, and specifically, a heat source which is more environmentally friendly.

Further settings where fuel cells are advantageously used include places where electric grid connections are available. However, the capacity of the electric grid may not be sufficient or sufficiently flexible or reliable to permit unrestrained use. For example, when charging electric batteries at a high rate (i.e. super charging batteries in a short amount of time), the load on the grid may be too high. In such settings, a fuel cell can be provided to passively charge a bank of batteries, which are then used to supplement the grid capacity. Alternatively, the bank of batteries may be used as a primary source of electricity, with the electric grid providing no, or supplemental amounts of electricity. This system of proving a fuel cell and a battery bank has an advantage of producing green electricity (e.g. when using hydrogen produced without carbon emission). Many of the above settings may have a further need for heat energy which cannot be simply or efficiently satisfied with current setups.

Heat or flow of thermal energy, either by conduction, convection, or radiation, is required in a broad variety of processes including heating, washing, drying, cocking, sterilizing, process heating, hardening, preheating of boiler feed water, evaporation for freshwater production and much more. In industrialised economies, for some process industry sectors, it has been estimated that consumption of energy for the generation of necessary process heat may account for around 55% to 75% of total consumption of energy. Furthermore, more than 95% of this heat is generated by the combustion of fossil fuels such as coal and oil.

The vast size and scale of industrial thermal requirements, clearly represents a challenge in the transition away from carbon-based fuels. Employing electric power to cover this heat demand is impractical for many reasons, one being electric grid balance and capacity. However, this demand also represents a unique opportunity for renewable hydrogen produced without emitting greenhouse gases or polluting wastes and furthermore for hydrogen-fuelled technologies that can efficiently generate zero-emission heat. Zero-emission heat refers to heat production which results in no emission generation. In the context of hydrogen energy generation, renewable hydrogen refers to hydrogen which has been produced through renewable means and results in minimal or zero emission. Traditionally, hydrogen can be generated through electrolysis, with the electricity used coming from non-renewable sources (e.g. coal fuel power plants). Hydrogen can be considered renewable when it is produced by electrolysis powered by renewable energy sources (e.g. solar, wind, hydroelectric). Renewable hydrogen may also be produced from biomass feedstock. There is therefore a need to further integrate the use of renewable hydrogen in energy generation.

According to a first aspect of the invention, there is provided an energy generation system comprising: a catalytic burner for producing heat energy; and an insulated vessel, wherein the insulated vessel surrounds the catalytic burner and the insulated vessel is a vacuum insulated vessel.

With this system, the catalytic burner generates heat and consequently the generated heat can be transferred to the inside of the vacuum insulated vessel. An advantage of using a vacuum insulated vessel is that heat lost to the outside of the vessel is reduced whilst the vessel can be made compact in size. This is in contrast to vessels using conventional insulation materials which need a larger capacity. It has been found that vacuum insulation works surprisingly well in context of the heat generated via the catalytic burner.

The insulated vessel may comprise a heat transfer medium (e.g. a fluid, or in some cases a solid) within the vacuum insulated vessel. The heat transfer medium could be used to provide heat to a load outside of the insulated vessel and/or may also allow for heat storage.

The heat transfer medium may also be used to receive heat from a secondary heat source, in addition to receiving heat via heat exchange from the catalytic burner. Heat may be received from one or more secondary heat source(s) via further heat exchange within the insulated vessel and/or by movement of the heat transfer medium in a circuit that passes outside of the insulated vessel. The secondary heat source may for example include a heat pump. Alternatively, or additionally the secondary heat source may include renewable heat from solar energy, waste heat from external processes such as industrial processes or any other source of heat. Where there is further heat exchange within the insulated vessel with heat from the secondary heat source(s) then this may use a secondary heat source coil within the insulated vessel.

In addition, or alternatively, the catalytic burner may be used to supply heat to replace and/or supplement heat from one or more secondary heat source(s), thereby acting as a back-up heat source, e.g. in case of electricity failure. The secondary heat source(s) may be as discussed above, e.g. including a heat pump. Thus, the catalytic burner may be used to supplement heat from a secondary heat source such as a heat pump and/or to replace heat from the secondary heat source in the event of a reduced ability for the secondary heat source to provide heat, for example due to problems with the electricity supply to a heat pump. By integrating the catalytic burner with a secondary heat source like a heat pump then it becomes possible to use the two heat sources together or interchangeably. Adding heat from a catalytic burner to heat from a heat pump can increase the thermal energy potential for heat pumps. Allowing for heat from a catalytic burner to replace heat from a heat pump enables a thermal energy demand to be satisfied independent of the flow of electrical energy from a grid or other electricity source for the heat pump (or other electrically powered secondary heat source). If this is combined with a fuel cell as well, e.g. as discussed below, then this further enhances the capabilities of the overall energy generation system since the fuel cell can if needed provide electricity to a secondary heat source.

The vacuum insulated vessel may comprise an inner shell. The inner shell may be made out of metal. The advantage of using a metal inner shell is that it may withstand higher temperatures. A metal inner shell may provide superior mechanical properties compared to inner shells made out of other materials.

The vacuum insulated vessel may comprise a support. The support may be placed at specific places on the inner shell, or may partially surround the inner shell, or alternatively may wholly surround the inner shell.

The vacuum insulated vessel may comprise an outer shell. The outer shell may be disposed around the inner shell and the support. The support may connect the inner shell and the outer shell.

The vacuum insulated vessel may comprise a volume between the inner shell and the outer shell that is a vacuum, and thus may provide the vacuum insulation for the insulated vessel. Applying a vacuum between the inner shell and the outer shell reduces the amount of heat transferred between the inner shell and the outer shell. For example, if present, any air (or gas molecules) between the inner shell and the outer shell will facilitate heat transfer by convection. Reducing or ideally avoiding such presence by applying vacuum will reduce or prevent such heat transfer. The inner shell and the outer shell may be distanced from each other by the use of a spacer to provide structural support to the outer shell around the inner shell and to ensure that the space between the outer shell and the inner shell is maintained. The spacer may be a part of the support.

The catalytic burner may be wholly within the insulated vessel, such that the insulated vessel is configured to provide insulation to the heat generated by the catalytic burner. That is, the section of the catalytic burner where heat is generated can be placed within the insulated vessel. The catalytic burner may be positioned wholly within the insulated vessel. This allows more heat to be retained within the insulated vessel, as compared to a catalytic burner which is partially outside of the insulated vessel, or wholly outside the insulated vessel.

The catalytic burner may comprise a catalyst. The catalyst may be in the form of a catalytic material provided on a surface that will contact with a fuel inside the catalytic burner. The catalyst may extend along the length of the catalytic burner. Advantageously, as set out in more detail below, the catalytic burner may include a tube such as a coil for flow of a fuel mixture through the catalytic burner, wherein the catalyst is provided on a surface that extends along the coil. The coil may comprise a coil-shaped fluid flow path, for flow of the fuel mixture. Another advantage of using catalytic combustion to generate heat is that heat can be generated fast and on demand, provided that fuel is available.

The energy generation system may comprise a fuel cell. Thus, the energy generation system may be a combined heat and power system, with heat being produced by the catalytic burner and/or as waste heat, and with electrical power being produced by the fuel cell. The fuel cell may use hydrogen as fuel to generate electricity. The fuel cell may also use oxygen to generate electricity, optionally the oxygen may be supplied from air in the atmosphere. The fuel cell may produce heat energy during the production of electricity. The heat produced by the fuel cell may be used to initiate the catalytic reaction of the catalytic burner. For example, the fuel mixture supplied to the catalytic burner, as well as the catalytic burner itself, may be at a temperature below the initiation temperature of catalytic combustion, such that catalytic combustion reaction will not begin. The heat generated by the fuel cell may be used to bring the fuel mixture, the catalytic burner, or both, to the initiation temperature or to a higher temperature. In this way, the catalytic combustion can initiate in the catalytic burner, without the need to provide or use other sources of heat (e.g. burning fossil fuels). Advantageously, the heat generated by the fuel cell is a waste heat, and using this heat may increase the efficiency of the energy generation system.

An energy generation system comprising a catalytic burner and a fuel cell is considered to be novel and inventive in its own right, including in some examples when absent the vacuum insulation feature. In particular, viewed from a second aspect, the invention may provide an energy generation system comprising: a catalytic burner for producing heat energy; an insulated vessel, wherein the insulated vessel surrounds the catalytic burner; and a fuel cell, wherein waste heat from the fuel cell can be provided to the catalytic burner and/or to the insulated vessel; wherein the catalytic burner includes a catalytic coil comprising a coil-shaped fluid flow path for flow of a fuel mixture and a catalytic surface extending along at least a part of the coil-shaped fluid flow path.

It will be appreciated that the features discussed above for the first aspect may be combined with the system of the second aspect, with inclusion or omission of the vacuum insulation features, and also that the features below may apply to a system with or without a fuel cell and with or without the catalytic coil features of the second aspect.

For example, a system with or without a fuel cell may comprise a secondary heat source that provides heat to the insulated vessel, such as by heating a heat transfer medium within the insulated vessel to provide added heat alongside via heat exchange from the catalytic burner. Heat may be received from one or more secondary heat source(s) via further heat exchange within the insulated vessel and/or by movement of the heat transfer medium in a circuit that passes outside of the insulated vessel. Alternatively, or additionally, the interconnection with the secondary heat source may allow the catalytic burner to provide heat to replace that provided by the secondary heat source, e.g. by transferring heat away from the heat transfer medium rather than transferring heat into it. The secondary heat source may for example include a heat pump. Alternatively, or additionally the secondary heat source may include renewable heat from solar energy, waste heat from external processes such as industrial processes or any other source of heat. Where there is further heat exchange within the insulated vessel with heat from the secondary heat source(s) then this may use a secondary heat source coil within the insulated vessel, so that in this system there may be at least two coils within the insulated vessel, one being the coil of the catalytic burner and the other being a secondary heat source coil. The secondary heat source coil may also be used for waste heat from the fuel cell, or alternatively the heat from the fuel cell may be conveyed to the insulated vessel by other means, such as via a dedicated fuel cell waste heat coil or through some other heat exchange system linked to the heat transfer medium.

In respect of any aspect of the invention, the catalytic burner may comprise a catalytic mesh. The catalytic mesh may comprise a strip. The strip may be at least partially coated with the catalyst. Optionally, the strip is wholly covered with the catalyst. The strip may have perforations or have other surface features. The perforations or other surface features increase the surface area of the strip, increasing the surface area of the catalyst applied to the strip. The other surface features may comprise a baffle or a plurality of baffles. The strip may be formed into a helical shape or a spring shape, e.g. in order to provide the coil-shape of the second aspect. An advantage of forming the catalytic mesh into a helical shape or a spring shape is that a larger surface area of the catalytic mesh can be provided in the same length.

The catalytic mesh may be placed at least partially inside the catalytic burner. The catalytic mesh placed at least partially inside the catalytic burner, allows the fuel mixture to catalytically combust inside the catalytic burner heat up the catalyst and the catalytic burner. The heat generated by the catalytic combustion may then be transferred to the inside of the insulated vessel. Another advantage of a catalytic mesh placed at least partially inside the catalytic burner, is that the catalyst mesh may be placed there before, during or after manufacturing of the catalytic burner. Furthermore, the catalyst mesh may be flexible and allow it to bend with the catalytic burner as it is formed into shape. That is, the catalyst mesh may be placed inside the catalytic burner, before the catalytic burner is formed into its final shape. In the case the catalytic burner is a coil made out of a tube or pipe, the catalytic mesh may be inserted into the straight tube or pipe before the tube or pipe is formed into the coil shape of the catalytic burner. Advantageously, the catalytic mesh may be removed from the catalytic burner and replaced with a different catalyst mesh without the need to disassemble the catalytic burner.

The catalytic burner may comprise a catalyst that is a surface catalyst. The surface catalyst may be the catalyst described above, applied to the inner surface of the catalytic burner. The surface catalyst may be applied to the surface of the catalytic burner in addition to a catalyst mesh. In the case the catalytic burner is a pipe, the surface catalyst is applied to the inner surface of the pipe. Advantageously, the surface catalyst is in direct contact with the catalytic burner allowing a faster and more reliable heat transfer between the catalytic surface and the catalytic burner. Furthermore, the surface catalyst may be applied to the catalytic burner before or after manufacturing and assembly. The surface catalyst may comprise a binding agent configured to bind the surface catalyst to the inner surface of the catalytic burner. The surface catalyst may be applied using at least one of micro contact printing, physical deposition, vapour deposition, atomic layer deposition, plasma-enhanced atomic layer deposition. The surface catalyst may be applied using other suitable coating process. It will be appreciated that the above described methods of application may be suitable for the catalytic mesh as well as the surface catalyst.

The catalytic burner may comprise a plurality of catalysts. For example, the catalytic burner may comprise a first section where a first catalyst is provided and a second section where a second catalyst is provided. The first catalyst and the second catalyst may be the same or they may be different. The first section and the second section may be the same, or they may be different, or they may partially overlap. The first section and the second section may be of the same lengths, or they may of different lengths. The first section and the second sections may extend through the minority of the catalytic burner, or they may extend through the majority of the catalytic burner, optionally they may extend through all of the catalytic burner.

The catalyst may comprise platinum (Pt) palladium (Pd), and/or rhodium (Rh), or other platinum group metals. The catalyst may comprise any other suitable catalyst material capable of producing a hydrogen oxidation reaction (i.e. catalytic combustion of hydrogen). The catalyst may comprise a combination of the above catalysts. The catalyst may comprise a support material. The support material may be any one of carbon, ceramics, metals, metal alloys and metal ceramic alloys, and optionally a combination of any of these. Catalysts comprising carbon support platinum group metals provide a lower combustion initiation temperature of hydrogen and oxygen. The initiation temperature may be around 40 °C to 60 °C, optionally the initiation temperature is around 50 °C. The catalytic combustion of hydrogen and oxygen (or other fuel mixtures) may heat up the catalyst to temperatures of above 50 °C, and optionally to above 200 °C. The catalytic combustion of hydrogen and oxygen (or other fuel mixtures) may heat up the catalyst to temperature ranges of between 100 °C and 1000 °C, optionally to temperature ranges of between 200 °C to 500 °C. In certain applications the temperature ranges may still exceed the above values.

The catalytic burner may comprise the catalyst along some or all of the length of the coil. If the catalyst is a catalytic mesh, the catalytic mesh may be disposed along some of the length of the coil, and optionally along most of the length of the coil. The catalytic mesh may be disposed along the whole length of the coil. An advantage of proving the catalytic mesh along a larger length of the coil is that more surface are of the catalytic mesh is provided in the catalytic burner.

Where a coil is used for the catalytic burner then there may be a heater at an inlet region of the coil. The heater may be for pre-heating fluids entering the catalytic burner, e.g. for pre-heating of fuel to aid initiation of the catalytic burning process in downstream parts of the catalytic burner. The heater may comprise an electrical heating element and/or a heat exchanger for receiving heat via a heat exchange fluid that is heated elsewhere. Where a fuel cell is a part of the system then the heat exchange fluid for the heater may be heated by waste heat from the fuel cell. The heater may take the form of a mesh extending over the cross-section of the coil at the inlet region. The mesh may have a filtering function. Alternatively or additionally the coil may include a filter at the inlet region.

The catalytic burner of any of the above aspects may be a plate heat exchange unit comprising a catalysis chamber. The catalysis chamber comprises a catalyst and is configured to allow catalytic combustion to proceed and generate heat. The catalyst of the catalysis chamber may be any of the above discussed catalyst types (e.g. a mesh catalyst or a surface catalyst). The generated heat is then transferred to the body of the plate heat exchange unit and/or a plate adjacent the catalyst chamber and then transferred to the insulated vessel. The plate heat exchange may comprise a single catalysis chamber, or may comprise multiple catalysis chambers. The plate heat exchange unit may be configured to comprise at least a surface where heat exchange takes place between the plate heat exchange unit and a medium, wherein the heat exchanged is generated by the catalytic combustion.

The energy generation system comprising a fuel cell may comprise a battery. The battery may be configured to store electrical energy generated by the fuel cell. An advantage of providing a battery with a fuel cell is that large amounts of energy can be stored. Furthermore, electrical energy can be provided at a higher rate than generated by the fuel cell alone.

The battery may be integrated with a fuel cell into a fuel cell assembly, and/or the battery may be a standalone component which is connected to the fuel cell via an electrical transfer means. An advantage of providing an integrated system is that the system may be easier to install and commission, without requiring multiple components being connected. An advantage of providing a separate fuel cell and a separate battery is that the system can be modularized and more flexible. For example, different uses may require batteries of different specifications (capacity, discharge rates, temperature requirements etc.), which can be accommodated more easily.

The battery may be a battery system comprising a plurality of individual batteries, connected together to form a single battery system.

In any of the aspects discussed above, the energy generation system may be an integrated system of all the discussed components or it may be a system comprising a number of standalone units. For example, the energy generation system may be a single integrated unit with each claimed component being integrated into the system. The single integrated unit may comprise a(the) catalytic burner, a (the) fuel cell and a (the) battery. The system may comprise an integrated unit comprising a fuel cell and a battery, and further comprise a stand-alone catalyst burner (i.e. the catalytic burner is not comprised in the single integrated unit).

The energy generation system may include multiple components connected in parallel or in series, such as multiple components in a modular arrangement allowing for ease of installation of systems with differing capacities and/or allowing for future expansion if needed. For example, there may be multiple catalytic burners connected in parallel or in series. Where a fuel cell and/or a secondary heat source is present then this too may involve multiple components connected in parallel or in series. There may be parallel and/or series connections for inputs and outputs, e.g. for a heat transfer system that outputs heat from a set of interconnected catalytic burners, or for fuel system inputs that provide fuel to a set of interconnected burners and/or fuel cells. The use of connections in parallel and/or in series may apply to flow paths for heat, e.g. flow paths for fluids, and/or to electrical connections, and so on.

The catalytic burner may be configured to be fluidly connected to a fuel inlet for a fuel mixture and/or to be fluidly connected to an exhaust. The fuel inlet may be placed outside of the insulated vessel and permit the fuel mixture to enter the catalytic burner. The fuel inlet may be configured with an inlet port for each component of the fuel mixture or the fuel inlet may be configured to comprise a single inlet port for the fuel mixture. The exhaust may be placed partially or wholly outside of the insulated vessel. The fuel mixture may be provided to the catalytic burner when the catalytic burner is at a certain temperature, optionally at an initiation temperature. The fuel mixture may be provided to the catalytic burner when the catalytic burner is below the initiation temperature.

The catalytic burner may comprise a tube. Optionally, the catalytic burner may be formed out of a tube. The tube may be formed to produce a coil, e.g. a coil-shaped flow path as mentioned above. As noted above there may be a catalytic material on one or more surfaces that extend along the coil, optionally inside the coil. The coil shape of the tube of the catalytic burner provides a large surface area of the catalytic burner which allow more efficient heat transfer. Another advantage of a coil shape of the tube is that a larger surface area for catalytic combustion can be provided, which allows more of the fuel mixture to combust. The coil may extend along the inner surface of the insulated vessel in the circumferential and in the axial direction. That is, the coil tube may be of a helical shape where the tube may extend along the inner circumference of the insulated vessel, and each successive rotation around the circumference of insulated vessel progresses the coil along the axial direction of the vessel. The coil may be rotated along the inner circumference of the insulate vessel a number of times, such that the catalytic burner extends partially along the axial dimension of the insulated vessel, and optionally extends along most of the axial dimension of the insulated vessel. The coil may be revolved around a central point in a way where each successive coil revolution is the same distance from the central point.

Where a coil is included in the catalytic burner then the coil may have volume between successive coils, such that there is no contact between the coils (e.g. an elongated spring configuration). An advantage of providing volume between successive coils is that more heat transfer medium can be provided in contact with the catalytic burner coils.

Alternatively, the coil may be formed such that successive coils are in contact with each other (e.g. a compressed spring configuration).

The coil may have a length in the range 8 to 16 meters when extended, such as in the range 10 to 14 meters. It may for example have a length of about 12 meters when extended.

The catalytic burner may be in the immediate vicinity of the inside wall of the insulated vessel, such that the catalytic burner is closer to the inside wall of the insulated vessel than the centre. Alternatively, the catalytic burner may be away from the inside wall of the insulated vessel such that the catalytic burner is closer to the centre of the insulated vessel than the inside wall.

The catalytic burner, the fuel inlet and the exhaust may be made out of a single component, with the catalytic burner, the fuel inlet and the exhaust defining different zones of the single component. The single component may be a tube and optionally may be a pipe. Alternatively, one or more of the catalytic burner, the fuel inlet and the exhaust may be made of different materials. For example, the fuel inlet may be made out of a polymer and configured to allow easy coupling with other components. The catalytic burner, the fuel inlet and the exhaust may be joined together with conventional means, for example by using clamps, welding, brazing or other connection means.

The fuel mixture may comprise a hydrogen-based fluid. A fuel mixture of a hydrogen-based fluid when combusted with oxygen is a cleaner energy source, as it results in water being the product of the reaction. This fuel mixture is therefore better for the environment and less harmful to people. Advantageously, the hydrogen of this fuel mixture can be generated using environmentally friendly or even carbon-zero methods. For example, the hydrogen can be generated by electrolysis of water using carbon-zero electricity. The hydrogen-based fuel mixture may be a fluid comprising some hydrogen, optionally it may be a fluid comprising mostly hydrogen. Alternatively, the hydrogen-based fuel mixture may be comprised of mostly hydrogen, and optionally it may be comprised wholly of hydrogen (e.g. pure hydrogen). Another advantage of using a hydrogen-based fuel mixture is that if a fuel cell powered by hydrogen is integrated in the energy generation system, a common fuel mixture for powering the catalytic burner and the fuel cell maybe provided. This may simplify the energy generation system.

The fuel mixture provided to the catalytic burner may comprise a fuel mixture that is substantially similar to, or identical to, the fuel mixture provided to the fuel cell. For example, the fuel mixture provide to the catalytic burner may include a fuel mixture from the same fuel source (e.g. the same reservoir, such as a fuel tank) as the fuel mixture provide to the fuel cell. In some cases this may be mixed with other components such as for pre-heating or to optimise one or both of energy efficiency of the overall system and/or energy utilisation of the catalytic burner. In some example implementations the fuel mixture supplied to the catalytic burner may comprise the fuel cell fuel mixture along with some or all of the fuel cell exhaust gas. Using the same fuel mixture may allow a simplified system, where only one fuel source is required to power both components (i.e. the catalytic burner and the fuel cell). The substantially similar fuel mixture may comprise hydrogen and oxygen, such as a mixture that may comprise hydrogen and air.

The energy generation system may comprise a single fuel connection for both of a catalytic burner and a fuel cell. The single fuel connection may provide a single connection point for providing fuel to the fuel cell and the catalytic burner. Where the energy generation system includes multiple catalytic burners and/or multiple fuel cells, or multiple other components, then the single fuel connection may allow for a parallel or series connection for the fuel cell(s) and the catalytic burner(s). Thus, the single fuel connection may include a manifold system or other fuel distribution system for providing the fuel to the fuel cell(s) and the catalytic burner(s). This fuel may be a component of a fuel mixture as described below, e.g. a hydrogen-based fluid intended to be mixed with an oxygen-containing fluid such as air.

Thus, where a fuel cell is present then advantageously the fuel cell and the catalytic burner may have a common supply for fuel, such as by having a common supply for a component (or all components) of a fuel mixture. An advantage of this is that the system may be simplified with only one connection point for fuel, optionally hydrogen fuel, being required. Furthermore, the provision of only a single fuel connection inlet may make the system more reliable and safer compared to system with two or more fuel connections, as there are fewer places where an error or fault can cause fuel leaks. Another advantage of using a single fuel connection for multiple components is that a simpler system is obtained, where only one connection point for a common fuel source is needed. This makes the system more reliable and safer compared to a system where a fuel connection is provided for each component. Another advantage of using a single fuel connection is that the system may only need a single fuel storage component (e.g. a single fuel tank) to operate. There may also be a single fuel supply system, e.g. using fuel supply pump(s) and or manifold(s) common to both the fuel cell(s) and the catalytic burner(s). Advantageously, there may be only one fuel storage component. This means that only one such component may need to be provided, checked, inspected and re-fuelled, as opposed to doing all of those operations to two or more fuel storage components. Another advantage of using a single fuel connection is that the number of fluid connections (e.g. pipes) can be minimized, with an exemplary system proving a single fluid connection between: the fuel storage component and the single fuel connection, the single fuel connection and the catalytic burner(s); and the single fuel connection and the fuel cell(s). This again can simplify the system and may make the energy generation system more reliable.

The fuel mixture may comprise an oxygen-containing fluid, e.g. it may be a mixture of the fuel and the oxygen-containing fluid. The oxygen-containing fluid may be ambient air. Ambient air is comprised of about 21% oxygen. An advantage of using ambient air as the oxygen-containing fluid is that it is readily available. It is therefore not necessary to provide a separate fuel tank containing ambient air. Instead, ambient air can be provided from the surrounding atmosphere. This can be achieved by using a fan or a blower or another means of providing air. Alternatively, the oxygen-containing fluid may be mostly oxygen, for example commercially grade oxygen gas provided in a pressurized cylinder. The advantage of using compressed oxygen is that lower amounts of nitrogen gas are provided in the fuel mixture. This can allow the catalytic burner to achieve a higher degree of efficiency and combust at a higher temperature without producing undesirable nitrogen species/pollutants.

The fuel mixture may comprise a hydrogen-based fluid and an oxygen-containing fluid. Advantageously, providing a fuel mixture of both the hydrogen-based fluid and the oxygen-containing fluid, dispenses with the need to provide fuel components at specific amounts. This can reduce the complexity of the system.

The heat transfer medium may be a liquid. An advantage of a liquid heat transfer medium is that heat transfer within the liquid is larger than compared to solid materials. This can prevent hot-spots from forming within the volume of the medium. Additionally, the fluid can be provided with a means of agitation, which can improve the distribution of heat within the medium.

The heat transfer medium may comprise water. The advantage of using water as the heat transfer medium is that water is readily available and not harmful. For example, it is easy to provide additional water to the system in case of a leak or water loss. Furthermore, any water than may leak from the system would not readily cause harm to users or nature around the system. This can result in a more environmentally friendly system. In one example, the heat transfer medium is mostly water, and optionally the heat transfer medium is wholly water.

The heat transfer medium may be glycol (i.e. ethylene glycol). Advantageously, glycol has a lower freezing temperature than water, and so it can be used in applications where the temperature of the heat transfer medium may fall below the freezing temperature of water (0 °C). Furthermore, glycol has a higher boiling point than water, and so it can be heated to higher temperatures than water before it starts turning to steam. In one example, the heat transfer medium is mostly glycol, and optionally the heat transfer medium is wholly glycol. Another advantage of glycol is that it is relatively environmentally friendly, breaking down in a short time.

The heat transfer medium may be a mixture of any of ethylene glycol, ethanol, propylene glycol and water.

The heat transfer medium may be a mixture comprising water and glycol. An advantage of using a mixture of water and glycol, is that it provides increase benefit compared to using pure water or pure glycol. For example, corrosion of some materials is prevented using a mixture of the two components. Another advantage is that the mixture may inhibit growth of microbes or fungi. Furthermore, the mixture may be tailored to provide a balance of freezing temperature, boiling temperature and specific heat capacity.

The heat transfer medium may be configured to at least partially surround the catalytic burner, e.g. by surrounding a coil that includes the catalytic burner. Optionally, the heat transfer medium wholly surrounds the catalytic burner. Advantageously, a large contact area between the heat transfer medium and the catalytic burner allows more heat to be transferred from the catalytic burner to the heat transfer medium.

The energy generation system may be configured to control the amount of heat provided to the heat transfer medium by controlling the amount of fuel provided to the catalytic burner. For example, the system may be configured to heat the heat transfer medium to less than 100 °C, and then limit the amount of fuel provided to the catalytic burner, to limit the amount of heat generated and transferred to the heat transfer medium.

This way, the temperature of heat transfer medium does not exceed a threshold temperature. The threshold temperature may be 100 °C. The temperature of the heat transfer medium may be monitored to control the operation of the energy generation system. Controlling the operation of the energy generation system may control the temperature of the catalytic burner and/or the catalyst. In different settings the threshold temperature may be higher than 100 °C or lower than 100 °C.

The insulated vessel may comprise a heater. The heater may be electric, and configured to generate heat when power is supplied to it. Alternatively, the heater may be powered by other means. The heater may be disposed to surround, or at least be near, the catalytic burner. As discussed elsewhere herein, the heater may be within the catalytic burner, such as inside an inlet region of a coil of the catalytic burner. The heater may be configured to provide pre-heat to the catalytic burner. An advantage of providing a heater within the insulated vessel is that the catalytic burner can be brought to a suitably high temperature, with any heat losses being transferred to the heat transfer medium inside the insulated vessel. Another advantage of providing a heater configured to pre-heat the catalytic burner is that the catalytic burner can be raised to a higher temperature allowing catalytic combustion to proceed. The heater may be a hybrid heater comprising an electric heater and a heat transfer means, such that heat can be provided to pre-heat the catalytic burner with electrical means and/or by transferring heat from another source. The other source may be a fuel cell, e.g. a fuel cell as described above such as the fuel cell of the second aspect. The electric heater may be disposed inside the inner shell of the insulated vessel, or the electric heater may be disposed between the inner shell and the outer shell of the insulated vessel. The electric heater may be a resistive heater or an induction heater. That is, the electric heater may be configured to generate heat through resistance of a conductor, or the electric heater may be configured to generate heat by application of electromagnetic fields. Optionally, the electromagnetic fields are applied to the catalytic burner and/or the insulated vessel.

At least some of the heat generated by the fuel cell, which may be waste heat from the point of view of the fuel cell, may be provided to the catalytic burner, so that the catalytic burner reaches at least the initiation temperature of catalytic combustion. The heat generated by the fuel cell may be provided to the catalytic burner using a heat transfer means. The heat transfer means may provide a cooling medium of the fuel cell to the catalytic burner, such as via heat transfer with heat transfer medium that is within the insulated vessel and in some case that flows though the insulated vessel and/or the heat transfer means. Alternatively or additionally the heat transfer means may provide for heat exchange between a fuel cell exhaust gas and the catalytic burner, such as via heat transfer with heat transfer medium that is within the insulated vessel and in some cases that flows though the insulated vessel and/or the heat transfer means. The heat transfer means may comprise a heat exchanger thermally coupled to the fuel cell and/or the fuel cell assembly, and a fan or a blower configured to pass cooling medium across the heat exchanger. The heat transfer means may comprise additional valves and/or outlets, configured to direct the cooling medium to the catalytic burner and/or other environments. The cooling medium may be ambient air. An advantage of providing additional valves and/or outlets to the heat transfer means is that the cooling medium can be switched between being provided to the catalytic burner or other environment, when for example, it is not desired to provide heat to the catalytic burner.

Advantageously, the heat generated by the fuel cell is provided to the catalytic combustion system to allow catalytic combustion to initiate. In the absence of the heat generated by the fuel cell, alternative heat needs to be provided to the catalytic burner to initiate catalytic combustion reactions. However, this heat may come from non-renewable sources and/or non-zero-carbon sources. Furthermore, some of these other alternative heat sources can be unsafe and/or dangerous. For example, flame can be applied to the fuel mixture to bring it to the right temperature, which risks spontaneous combustion of the fuel mixture and possibly explosion. Advantageously, the heat that is generated by waste heat from the fuel cell may not be high enough to cause spontaneous combustion of for example hydrogen and oxygen (i.e. combustion in the absence of a catalytic material), but is sufficient enough to initiate (controlled) catalytic combustion of the fuel mixture. For example, the energy generation system may be configured to use at least some of the waste heat in a way that avoids combustion temperatures, or in some cases the fuel cell may by its nature be incapable of producing heat at an unsafe level, at least in normal use. Furthermore, in a conventional fuel cell, the heat generated by the fuel cell is vented to the atmosphere resulting in a lower overall efficiency of the system. When the heat generated by the fuel cell is used to heat up the fuel mixture and/or the catalyst, more energy is extracted from the fuel cell fuel mixture, increasing the overall efficiency of the fuel cell.

In some examples, the fuel cell exhaust gas is flowed into the catalytic burner, e.g. via flow through a coil of the catalytic burner. This is another option to provide waste heat from the fuel cell to the catalytic burner. The fuel cell exhaust gas may for example be at a temperature of 40 °C to 60 °C. This can be used to increase the temperature of the gas mixture in the catalytic burner. In addition, flowing the fuel cell exhaust through the catalytic burner can allow for any uncombusted fuel and/or air to be combusted within the catalytic burner. Where the fuel cell uses hydrogen then there can be a small amount of hydrogen remaining in the exhaust, and this hydrogen enriched exhaust can be mixed with the air/oxygen containing gas supplied to the catalytic burner.

The heat transfer means may comprise a catalyst heating heat transfer means. The catalyst heating heat transfer means may be configured to connect the fuel cell and the catalytic burner, so that heat is transferred from the fuel cell to the catalytic burner. The catalyst heating heat transfer means may comprise a pipe or a hose connection. The catalyst heating heat transfer means may comprise coupling means to connect and disconnect to the fuel cell and the catalytic burner, configured to pass a cooling medium from the fuel cell to the catalytic burner. The cooling medium may be passed through the catalytic burner to raise the temperature of the catalytic burner and/or the temperature of the catalyst. The cooling medium may be air. The cooling medium may be urged from the fuel cell to the catalytic burner with the use of a mechanical device, optionally with the use of a fan or a blower. The cooling medium may be directed through a fluid conduit, from the fuel cell to an inlet of the catalytic burner.

The heat transfer means may comprise a fuel heating heat transfer means, configured to transfer heat from the fuel cell to the fuel mixture of the catalytic burner. At least some of the heat generated by the fuel cell, which may be waste heat, may be provided to the fuel mixture with the use of the fuel heating heat transfer means. The heat generated by the fuel cell may be provided to the fuel mixture before the fuel mixture enters the catalytic burner. As noted above this may be done in some cases by mixing the fuel cell exhaust gas with the gases provided to the catalytic burner. The heat generated by the fuel cell may be used to pre-heat the fuel mixture either directly (e.g. by mixing) or via heat exchange (e.g. in a heat exchanger of the heat transfer means), allowing catalytic combustion to initiate and proceed. The fuel heating heat transfer means may comprise a fuel mixture heat exchanger configured to transfer heat from the cooling medium to the fuel mixture. An advantage of this system is that heat is effectively transferred to the fuel mixture, pre-heating the fuel mixture and allowing catalytic combustion to proceed. The heat transfer means may be a closed loop cooling system, with a cooling medium circulating through. The cooling medium may be water. Alternatively, the cooling medium may be another suitable fluid.

The heat transfer means may comprise a heat recovery heat transfer means. The heat recovery heat transfer means may comprise a heat exchanger configured to transfer heat from the fuel cell to the catalytic burner. The heat recovery heat transfer means may comprise a catalytic burner heat exchanger configured to transfer heat from the cooling medium to the catalytic burner. The cooling medium may be water. Advantageously, the heat recovery heat transfer means may be disconnected from one or both of the fuel cell and the catalytic burner allowing the components to be interchangeable (i.e. disconnect an old fuel cell and connect a new fuel cell to the catalytic burner).

The heat transfer means may comprise only one of, or any combination of: the catalyst heating heat transfer means, the fuel heating heat transfer means, and the heat recover heat transfer means. The above types of heat transfer means may share common components such as common pipes, conduits, heat exchangers, blowers etc. The above types of heat transfer means may be all separate, with individual components for each means. The heat transfer means may connect with a secondary heat source, such as a connection to a heat pump or another type of heat source as mentioned above. This can allow heat to be transferred in from the secondary heat source into the insulated vessel and/or it can allow heat from the insulated vessel (e.g. provided by the catalytic burner) to be transferred out into flow paths associated with the secondary heat source, e.g. so that heat from the insulated vessel can replace or supplement heat from the secondary heat source by heating a fluid loop connected with the secondary heat source. This can allow the catalytic burner to be a back-up (or booster) for a secondary heat source.

The energy generation system, with or without a fuel cell, may comprise a heat pump, e.g. as the secondary heat source discussed above. If the energy generation system includes both of a fuel cell and a heat pump then the insulated vessel may receive heat from both fuel cell waste heat and from a heat output of the heat pump (e.g. a heat rejecting exchanger thereof). The fuel cell may be used to provide electricity for the heat pump.

The fuel cell may be provided with a heat exchanger and/or cooling system that allows the heat generated by the fuel cell to be directed to the atmosphere, to the catalytic burner, or a combination of the two. For example, in a situation where a catalytic burner is not functioning, an operating fuel cell continues to generate heat which is then vented to the atmosphere for the purposes of keeping the fuel cell at an acceptable temperature. If subsequently, the catalytic burner requires some heat, the heat exchanger and/or cooling system configures the heat output to provide some or all of the heat generated by the fuel cell to the catalytic burner via any one of the above described heat transfer means.

In the case where the heat generated by the fuel cell is provided to the fuel mixture before it enters the catalytic burner, a greater efficiency of the catalytic burner can be achieved. In conventional catalytic burners, a cold fuel mixture is provided to the catalyst, which then absorbs some heat from the catalyst before it is able to combust. The heat absorbed by the cold fuel is then not-available to do work (i.e. to be used as heating). When the fuel mixture is provided to the catalytic burner at higher temperatures (i.e. higher than cold fuel mixture), the fuel mixture does not need to absorb any, or at least not as much, heat from the catalytic burner to combust. This will improve the efficiency of the catalytic burner.

The energy generation system may comprise a number of sensors to monitor and measure condition of the system. A temperature sensor may be provided in the system to monitor and control the operation of the system. A temperature sensor may be provided in the catalytic burner to measure and/or control the temperature of the catalytic burner. The temperature sensor may be used to detect when catalytic combustion initiation temperature is reached by the catalytic burner. Advantageously, the sensor data can be used to control the operation of the system, for example, the system may detect when the initiation temperature is reached and when pre-heating of the system is complete. This may allow the system to stop providing heat to the catalytic burner and/or start providing fuel mixture to the catalytic burner.

The insulated vessel may be a pressure vessel. A pressure vessel is a vessel configured to hold fluid at pressures above ambient pressure. Advantageously, a larger amount of energy can be generated and/or stored by a pressure vessel. The insulated vessel may be a sealed vessel. The insulated vessel may be a sealed vessel containing the heat transfer medium. The insulated vessel may be configured to retain most, optionally, all of the heat transfer medium within the insulated vessel with minimal losses to the environment. The insulated vessel may comprise at least one inlet. The at least one inlet may also function as an outlet. The insulated vessel may comprise a single inlet for allowing the heat transfer medium to flow into the insulated vessel and a single outlet to allow the heat transfer medium to flow out of the insulated vessel. The at least one inlet may be a thermostatic mixing valve. An advantage of using a thermostatic mixing valve is that better control of the heat transfer medium temperature can be achieved. The at least one inlet may be fluidly connected to a component configured to extend through the insulated vessel and configured to direct the inlet heat transfer medium near the bottom of the insulated vessel. Advantageously, providing the heat transfer medium near the bottom of the insulated vessel improves the efficiency of the system and/or improved heat exchange to the heat transfer medium.

The insulated vessel may comprise a safety valve, optionally a pressure valve. The safety valve may be configured to prevent the pressure inside the vessel exceeding a certain threshold. An advantage of that is that the system operates safely.

The insulated vessel may comprise an expansion means configured to accommodate thermal expansion of the medium in the insulated vessel. The expansion means may be integrated in the insulated vessel or may be provided separately. The expansion means may comprise an expansion chamber. The expansion means may comprise a membrane configured to deflect from a relaxed position to a pressurized position in response to increasing pressure inside the insulated vessel.

The inner shell may be configured to have an increased corrosion or degradation resistance for a specific material inside the insulated vessel. The increase resistance can be achieved by conventional means such as alloying the metal with addition elements, proving a layer of corrosion resistant material (e.g. galvanising with zinc or case-hardening). Advantageously, this may prolong the lifetime of the inner shell. The inner shell may be made from a high grade alloy, optionally the high grade alloy may be a stainless steel.

The inner shell may comprise two dished ends. Dished ends are end-caps that may be welded to a main body to form a pressure vessel. The dished end may comprise a straight flange height, a knuckle and a crown. The dished ends may be deep dished ends, such that the straight flange height is substantially larger than commercial dished ends. An advantage of using two deep dished ends to construct a vessel (as compared to using two dished ends and a cylindrical body) is that only one joint is needed to form the vessel (as compared to two joints conventionally). The joint is formed between the straight flange of the two deep dished ends. The advantage of this is that a lower number of joints leads to a more reliable vessel (i.e. fewer points of failure). Furthermore, a deep dished end vessel is simpler to manufacture in terms of the number of joints needed. The joint between the two deep dished ends may be formed by welding or bonding.

The dished ends of the inner shell may be made from metal, and optionally made out of steel or aluminium. The dished ends may be made from stainless steel. The dished ends may be manufactured by methods of hot forming, cold forming, deep drawing, spinning, forming a crown and petals, dishing or flanging. Each dished end may be manufactured by a different method, or optionally, all the dished ends may be manufactured by the same method. Each manufacturing method may provide benefits to the final vessel in certain applications. For example, one method of manufacturing may provide a vessel that is resistant to mechanical damage, which another method may provide a vessel that is resistant to chemical damage.

The deep dished ends may be formed by deep drawing to provide a length of the straight flange that extends to half of the length of the vessel to be formed. The deep dished end may be of fixed diameter along the straight flange. The deep dished end may be formed out of a standard vessel dished end (i.e. an off-the shelf end cap of a vessel). The deep dished end may be formed by applying force and/or heat to the standard end cap.

The dished ends may have a shape of any one of flat, conical, standard, torispherical, semi-elliptical and ellipsoidal. The dished ends may have a thickness in the range of 0.2 mm to 8 mm. The thickness of the dished ends may depend on the pressures of the system. For example, a system designed to withstand higher pressures may comprise dishes ends with a larger thickness. A system designed to withstand lower pressures may comprise dished ends with a smaller thickness. In certain applications the thickness may be below 0.2 mm or above 8 mm.

The diameter of the dished ends, and/or the vessel, may be in the range of 0.2 m to 8 m. The diameter of the dished ends and/or the vessel may be dictated by the application of the system. For example, the diameter may be in the ranges of 350 mm to 500 mm. An advantage of using a diameter of this range is that the system may be integrated in a domestic setting. The diameter may be in the ranges of 500 mm to 2500 m, optionally the diameter may be 1600 mm or thereabout. The advantage of using a diameter of this range, and optionally of this value is that the system may be integrated well in an industrial setting. For example, a diameter of around 1600 mm may provide an efficient combination of system cost, system size and energy generation. In some specialist industrial uses, the diameter may be larger than 1600 mm. For example, in setting where vessel diameters of between 2000 mm and 8000 mm are common, an energy generation system of this size range may be integrated well. Smaller diameters allow the tank to be compact and placed in areas that are low on space. Larger diameters of the vessel are preferable in settings where large amounts of heat need to be transferred. A better volume to surface area ratio is therefore achieved with larger diameters.

The support (or spacer) may comprise cellulose fiber, and optionally comprise at least one of cardboard, fibreboard, bamboo and polymer. The support may comprise other insulating material (i.e. a material with a low thermal conductivity), such as polymers, foams, gels. The support may have insulating properties, that is have a relatively low thermal conductivity. The support may have a lower thermal conductivity than the inner and/or outer shell. For example, the support may have a thermal conductivity of 1 Wm⁻¹ K⁻¹ or less. Optionally, the support may have a thermal conductivity of 0.1 Wm⁻¹ K⁻¹ or less, and even more optionally, a thermal conductivity of 0.05 Wm⁻¹ K¹ or less. The support may be perforated, allowing a vacuum to be applied to the perforated spaces. That it, the support may be non-continuous such that it does not contact the inner shell across the whole surface area. Advantageously, this provides a smaller area of thermal contact, where heat can be transferred from the inner shell to the support (spacer), and optionally further to the atmosphere.

The support may comprise more than one support. The support may comprise a plurality of discontinuous pieces of support. That is, the support may comprise two, three or four separate sections of support material, all together encompassed by the support.

The support may be placed between the inner shell and the outer shell to prevent the inner shell and/or the outer shell from deforming due to vacuum. This is, applying vacuum between the inner shell and the outer shell may exert forces which lead to deformation of the inner shell and the outer shell material. In conventional vacuum vessels, the inner shell and the outer shell are manufactured to withstand vacuum forces which necessitates the use of thicker walls and/or other supporting means. The use of the support advantageously reduces the amount of material required to form the inner shell and/or the outer shell. Furthermore, in other conventional vacuum vessels, strong supports comprising metals may be used to provide structural strength to the vessel. However, these metal supports provide good thermal conductivity between the shell and the inner outer shell, increasing the amount of heat that is lost. Advantageously, using the support material as described above, reduces and/or eliminates the need of proving supports which increase the amount of heat lost, thereby reducing the amount of heat lost. The outer shell may be manufactured/formed by similar means to the inner shell. For example, the outer shell may be formed by joining two dished ends, and specifically two deep dished ends. The two deep dished ends of the outer shell may be positioned at either end of the inner shell, surrounding the inner shell and the support, and then joined together to form the outer shell. The inner shell and the outer shell may be separated from each other by a distance, and the distance may be defined by the support.

The support may be placed around in the mid-body region of the vessel, so that support is provided to the are most likely to deform under vacuum. The mid-body of the vessel, that is the area where the two dee dished end are joined together, is the area of the shell where forces may deform and/or buckle the shell. The support may be placed along the whole circumference of the mid-body. The support may be placed at specific areas around the mid-body, for example at two opposing ends of the mid-body cross-section (i.e. at two opposing ends of the body). The support may be placed at more than two places, such as for example at thee placed, at four placed, at five places etc. The support may be arranged uniformly around the circumference (e.g. if the support is placed at five places, they may be separated by approximately 72 degrees around the circumference of the inner shell).

The insulated vessel may be a spherical vessel. The spherical insulated vessel may comprise a spherical inner shell and a spherical outer shell.

The outer shell, made out of metal, may comprise a surface layer. The surface layer may be a polymer. The surface layer may be configured to protect the outer shell from damage and degradation, and/or provide a further layer of thermal insulation.

The outer shell may be provided with an outer skin, for example to provide protection and/or additional thermal insulation. The outer skin may comprise a layer of thermal insulation. The outer skin may be made out of a thermally insulating materials, for example a polymer, and optionally neoprene. The use of a polymer outer skin has an advantage of providing lightweight and inexpensive material. Furthermore, the outer shell made from polymer may have higher insulating properties. Another advantage of using an outer skin disposed on the surface of the outer shell is that it provides protection for the outer shell. By means of the outer skin the outer shell may be protected from mechanical damage, or chemical damage.

The insulated vessel may comprise a base. The base may be attached to the inner shell or the outer shell. The base allows the insulated vessel to stand on a flat surface or be attached to a surface and keep the insulated vessel steady.

The insulated vessel may comprise a medium inlet/outlet. The medium inlet/outlet allows heat transfer medium to be introduced to the inside of the insulated vessel. The heat transfer medium introduced may be a cold heat transfer medium. The medium inlet/outlet may permit warm or hot heat transfer medium to be taken out of the insulated vessel as needed.

A vessel as described above is considered novel and inventive in its own right.

Another aspect of the invention is a vessel comprising a first shell, wherein the first shell is manufactured by joining two deep dished ends together. The vessel may comprise any of the optional features discussed above in relation to the insulated vessel of the first or second aspect.

Sensors may be used to monitor and/or control the amount of fuel mixture provided to the catalytic burner. The energy generation system may comprise a suitable control system to perform such monitoring/control functions along with other control functions of the system such as those discussed below. Advantageously, the rate of catalytic combustion can be controlled by providing different amounts of fuel mixture to the catalytic burner. The system may increase the amount of fuel mixture provided to the catalytic burner to increase the rate of catalytic combustion and increase the rate of heat generation. The system may decrease the amount of fuel mixture provided to the catalytic burner to decrease the rate of catalytic reaction and decrease the rate of heat generation. Another advantage of controlling the rate of reaction is that an optimal heat generation can be achieved. This optimal heat generation may be determined by longevity of the system (i.e. limiting damage to components by long-term heat exposure) and/or the amount of heat needed in the system.

In some configurations, the energy generation system may be configured to provide an increased rate of heat generation in the catalytic burner, so that the heat transfer medium can be brought to a desired temperature faster. In this configuration, the fuel mixture may be provided to the catalytic burner at an increased rate, which may lead to elevated temperatures of the catalytic burner. The catalyst may be configured to withstand higher temperatures by changing the composition of the catalyst.

According to another aspect of the invention a method of operating an energy generation system for producing heat is provided. The method comprises: producing heat energy with a catalytic burner of the system; and transferring the produced heat to an insulated vessel, wherein the insulated vessel surrounds the catalytic burner and the insulated vessel is a vacuum insulated vessel.

The method may comprise operating an energy generation system of the first aspect, optionally, with any or all of the optional features of the first aspect discussed above. The method may comprise providing a fuel mixture to the catalytic burner. The method may comprise pre-heating the catalytic burner. The pre-heating may comprise providing heat to the catalytic burner, optionally, wherein the heat is waste heat.

According to another aspect the invention provides a method of operating an energy generation system for producing heat and/or electrical power. The method comprises: producing heat with a catalytic burner of the system; transferring the produced heat to an insulated vessel, wherein the insulated vessel surrounds the catalytic burner; and operating a fuel cell of the system, wherein waste heat generated by the fuel cell is provided to the catalytic burner and/or the insulated vessel; wherein the catalytic burner includes a catalytic coil comprising a coil-shaped fluid flow path for flow of a fuel mixture and a catalytic surface extending along at least a part of the coil-shaped fluid flow path.

The method may comprise providing a fuel mixture to the catalytic burner and combusting the fuel mixture via catalytic combustion. The method may comprise generating heat in the catalytic burner, and transferring the heat to a heat transfer medium of the insulated vessel. The method may comprise transferring the heat from the heat transfer medium to the outside of the insulated vessel.

The method may comprise operating an energy generation system of the second aspect, optionally, with any or all of the optional features of the second aspect discussed above. The method may comprise providing a fuel mixture to the catalytic burner, optionally, providing the fuel mixture to the catalytic burner such that the fuel mixture flows through the coil-shaped fluid flow path. The method may comprise producing a catalytic combustion of the fuel mixture in the coil shaped fluid flow path. The method may comprise providing the waste heat generated by the fuel cell to the catalytic burner to pre-heat the catalytic burner, e.g. via heat exchange or via mixing of the fuel cell exhaust into the fluids flowing through the catalytic burner.

The method may comprise providing a fuel mixture to the catalytic burner and combusting the fuel mixture via catalytic combustion. The method may comprise generating heat in the catalytic burner, and transferring the heat to a heat transfer medium of the insulated vessel. The method may comprise transferring the heat from the heat transfer medium to the outside of the insulated vessel.

The method may comprise providing fuel to a fuel cell to generate electricity. The fuel call may generate heat. The heat generated by the fuel call may be transferred to the catalytic burner and/or the insulated vessel. The heat generated by the fuel cell may be used to pre-heat the catalytic burner to or above a catalytic initiation temperature. The pre-heating may comprise providing heat to the fuel mixture before it enters the catalytic burner, and/or providing heat to the catalytic burner and/or providing heat to the medium in the vessel.

According to another aspect of the invention, a method of manufacturing the energy generation system of the first aspect is provided. The method comprises providing a catalytic burner and an insulated vessel, wherein the insulated vessel surrounds the catalytic burner and wherein the insulated vessel is a vacuum insulated vessel.

The method may comprise providing the energy generation system of the first aspect with any or all of the optional features discussed above. According to another aspect of the invention, a method of manufacturing the energy generation system of the second aspect is provided. The method comprises providing a catalytic burner, an insulated vessel and a fuel cell, wherein the insulated vessel surrounds the catalytic burner, wherein the waste heat from the fuel cell can be provided to the catalytic burner and/or to the insulated vessel and wherein the catalytic burner includes a catalytic coil comprising a coil-shaped fluid flow path for flow of a fuel mixture and a catalytic surface extending along at least a part of the coil-shaped fluid flow path.

The method may comprise providing the energy generation system of the second aspect with any or all of the optional features discussed above.

It is apparent that the optional features discussed above may be combined together where reasonable, and that the optional system features discussed in relation to the first or second aspect may be provided with a corresponding method of operating the features.

The energy generation system above, may be integrated with other heat generating industrial processes, where heat or waste heat of the industrial process is used to pre-heat the catalytic burner.

The method may comprise inserting a mesh catalyst into the tube of the catalytic burner. The method may comprise applying a catalytic surface to the inside of the tube of the catalytic burner.

The method may comprise placing the catalytic burner inside a vessel.

According to another aspect of the invention, a method of manufacturing a vessel is provided. The method comprises the steps of: forming a first deep dished end; and forming a second deep dished end; joining the first deep dished end and the second deep dished end at the straight flange of each deep dished end to form a shell.

The method may comprise the steps of: providing a support around the shell; providing a second pair of deep dished ends; placing the second pair of deep dished ends around the shell and around the support; and joining the second pair of deep dished ends to form a second shell, wherein the first shell is an inner shell and the second shell is an outer shell.

Certain embodiments of the invention will now be described, by way of example only, and with reference to the accompanying drawings in which:

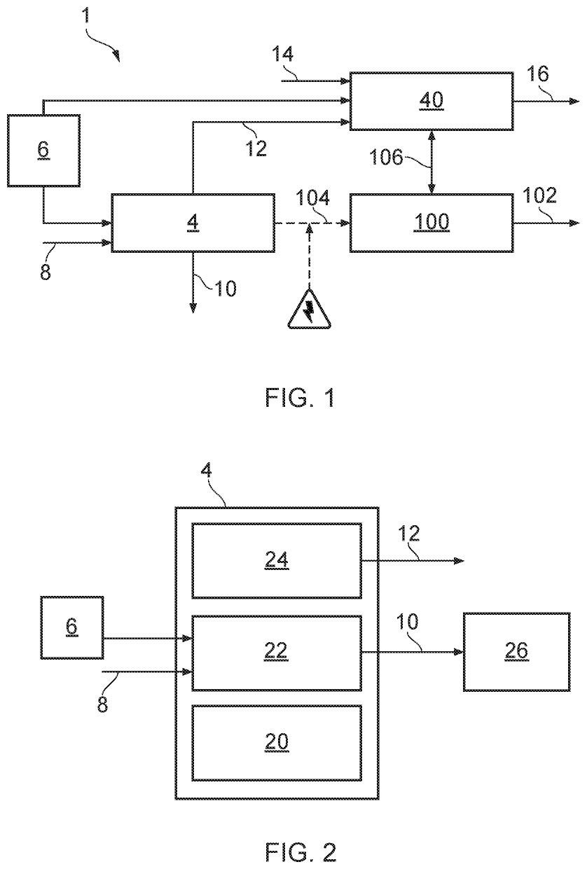

FIG. 1 shows a diagram of an energy generation system;

FIG. 2 shows a diagram of a fuel cell assembly;

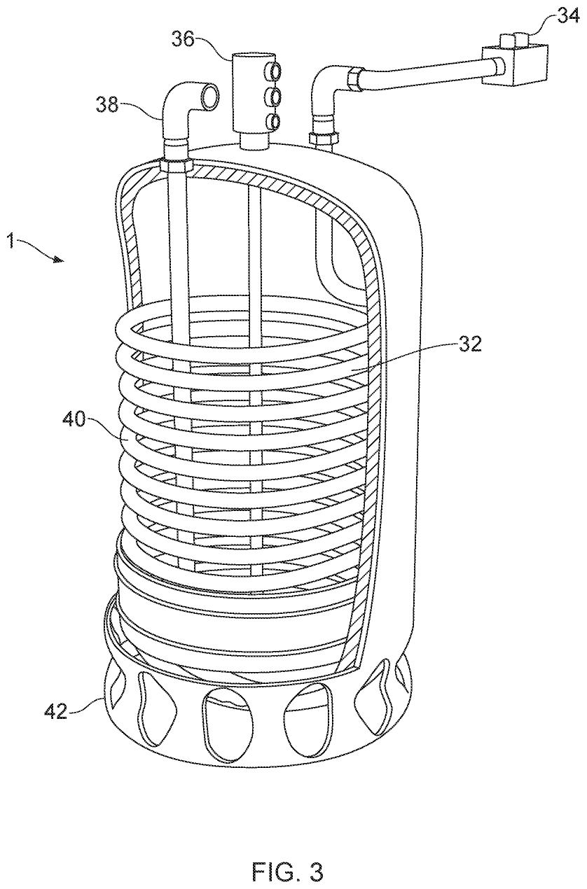

FIG. 3 shows an illustration of an energy generation system;

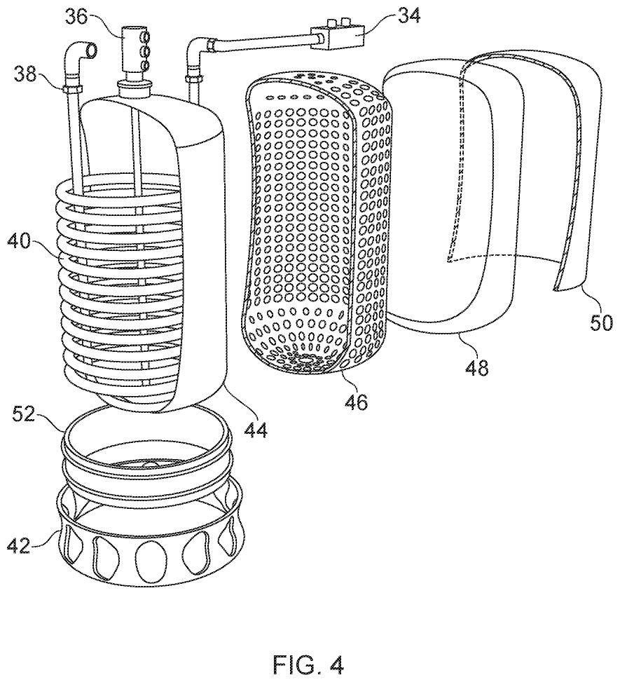

FIG. 4 shows an exploded-view illustration of the system of FIG. 3;

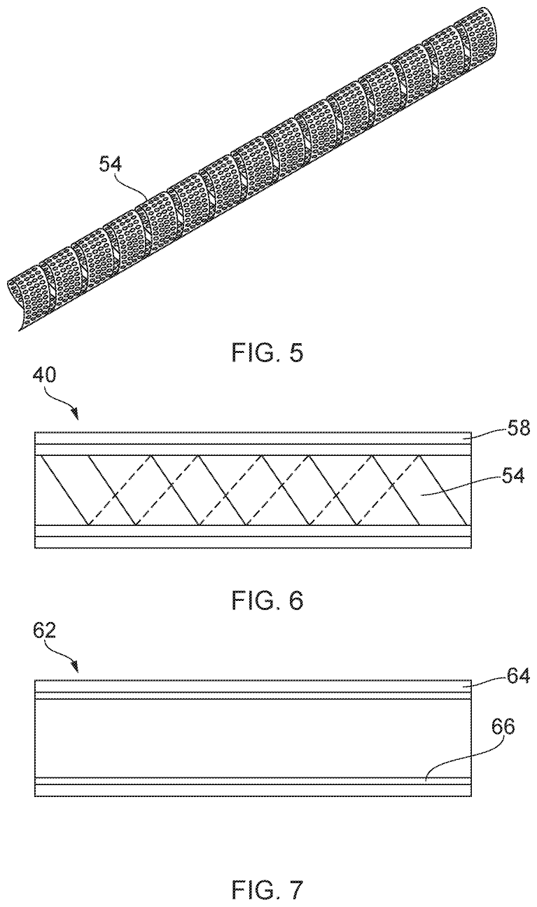

FIG. 5 shows an illustration of a mesh catalyst;

FIG. 6 shows a diagram of a catalytic burner with the mesh catalyst;

FIG. 7 shows a diagram of a catalytic burner with a surface catalyst; and

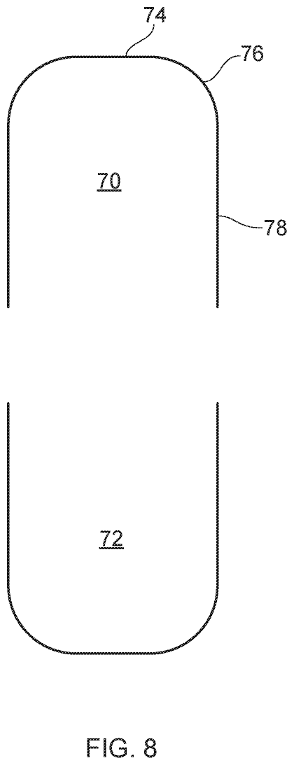

FIG. 8 shows a diagram of deep dished ends.

FIG. 1 shows an energy generation system 1 for providing heat and power. The energy generation system 1 comprises a catalytic burner 40, a fuel cell assembly 4 and a hydrogen source 6. The fuel cell assembly 4 is connected to the hydrogen source 6 and to an oxygen source 8. The oxygen source 8 is typically ambient air comprising oxygen. The catalytic burner 40 is connected to the hydrogen source 6 and to an oxygen source 14. The oxygen source 14 is typically ambient air comprising oxygen. The fuel cell assembly 4 is connected to the catalytic burner 40 with a heat transfer means 12. The catalytic burner 40 is configured to transfer heat via a heat transfer means 16 to provide heat to be used by a heat load, e.g. a heating system of a building or some other heat load.

In some example the energy generation system 1 also includes a secondary heat source 100, such as a heat pump system 100. The heat pump system 100 is configured to supply heat to a heat load 102, e.g. a heating system of a building or some other heat load. This may be the same heat load as is supplied by the catalytic burner 40. The heat pump system 100 receives electricity via an electrical supply system 104, which can include electricity generated by the fuel cell assembly 4 if needed, depending on the availability of external electrical energy and on considerations of cost and efficiency for the overall system. The electricity may also be provided by a locally situated renewable energy source, e.g. wind or solar, with the fuel cell acting to ensure stable supply in cases of variable production at the renewable energy source. The heat pump system 100 may be connected with the catalytic burner 40 via heat input/output connection 106 in order that the heat pump system 100 can receive heat from the catalytic burner 40. In this way the heat from the catalytic burner 40 can supplement or replace heat from the heat pump system 100, e.g. to ensure adequate heat in cases of reduced electricity supply without the need to significantly change the infrastructure of the heat pump system 100. Instead, the accumulator of the heat pump system 100 can be combined into the catalytic burner 40, e.g. as an insulated vessel thereof such as the insulated vessel 32 that is described below. Additionally, the heat pump system 100 can supply heat into the catalytic burner 40, e.g. for pre-heating or as a supplemental heat source for the heat load 16 of the catalytic burner 40.

FIG. 2 shows a fuel cell assembly 4. The fuel cell assembly 4 comprises a controller 20, a fuel cell 22 and a cooling system 24. The fuel cell 22 is configured to use a fuel mixture to generate electricity. The fuel cell 22 is connected to a battery 26 via an electric transfer means 10. The battery 26 can be integrated in the fuel cell assembly 4 or, as illustrated in FIG. 2, is a standalone battery 26 connected to the fuel cell assembly 4. The cooling system 24 is configured to exchange heat between the fuel cell 22 and/or the fuel cell assembly 4 and an external environment. The cooling system 24 is connected to the external environment via a heat transfer means 12. The cooling system 24 of FIG. 2 comprises a heat exchanger in thermal communication with the fuel cell and a fan for blowing air across the surface of the heat exchanger. In conventional fuel cell assemblies 4, the external environment is ambient air. As discussed in relation to FIG. 1, the external environment of the energy generation system 1 is the catalytic burner 40.

The controller 20 of the fuel cell assembly 4 is configured to control the operation of the fuel cell assembly 4, the fuel cell 22, the cooling system 24 and any other auxiliary components of the fuel cell assembly 4. The controller 20 can comprise an interface with which an operator interacts with the fuel cell assembly 4. The controller 20 controls the operation of a fan comprised in the cooling system 24, and controls the amount of air that is provided across the heat exchanger. In systems where the fuel cell assembly 4 and the catalytic burner 40 are integrated, the controller 20 can control the operation of the catalytic burner 40 and control the provision of fuel to the catalytic burner 40.

During operation of the fuel cell 22, hydrogen from the hydrogen source 6 and oxygen from the oxygen source 8 are converted into electrical energy in the fuel cell 22, which is then transferred to the battery 26 via the electric transfer means 10, such as electrical cables. The fuel cell 22 also generates heat which is typically expelled into ambient air for cooling purposes. In FIGS. 1 and 2, the heat generated by the fuel cell assembly 4 is transferred to the catalytic burner 40 via the cooling system 24 and the heat transfer means 12.

The heat transfer means 12 comprises a hose fluidly connecting the cooling system 24 and the catalytic burner 40. During cooling of the fuel cell 22 in the fuel cell assembly 4, the fan blows ambient air across the heat exchanger of the cooling system 24. The heat exchanger transfers heat from the fuel cell to the air, lowering the temperature of the fuel cell and increasing the temperature of the air. At least some of the air is directed to the heat transfer means 12 and then through the heat transfer means 12 to the catalytic burner 40.

FIG. 3 shows a view of a part of an energy generation system 1 with a catalytic burner 40. The energy generation system 1 comprises a vessel 32 which is an insulated vessel, a fuel inlet 34, a medium inlet/outlet 36, an exhaust 38, a catalytic burner 40 and a base 42. The fuel inlet 34 is configured to receive a fuel mixture and is fluidly connected to the catalytic burner 40. The catalytic burner 40 defines the volume where catalytic reaction occurs and is fluidly connected to the exhaust 38. The catalytic burner 40 comprises a catalyst facilitating a catalytic reaction of the fuel mixture. The medium inlet/outlet 36 is fluidly connected with the interior volume of the vessel 32 and allows a fluid, which is a heat transfer medium, such as water to enter the vessel 32. The base 42 is attached to the exterior of the vessel 32 and stabilizes the vessel 32 when installed at a site.

In the system of FIG. 3, the catalytic burner 40 is a tube taking the form of a helix inside the vessel 32. The helical catalytic burner 40 is configured to provide a large surface area between the catalytic burner 40 helix and the heat transfer medium. The heat transfer medium, once introduced to the vessel 32, surrounds the catalytic burner 40. The catalytic burner 40 and the exhaust 38 are formed of a single tube. The fuel inlet 34 is a separate device connected to a pipe and fluidly connected to the catalytic burner 40.

Before catalytic combustion of the fuel mixture can happen in the catalytic burner 40, the catalytic burner 40 is pre-heated to the initiation temperature or above. In the energy generation system of FIGS. 1, 2 and 3, pre-heating of the catalytic burner 40 comprises transferring heat generated by the fuel cell 22 to the catalytic burner 40. The air provided across the heat exchanger is directed through the heat transfer means 12 to the catalytic burner 40 through the fuel inlet 34. The air, at an elevated temperature, flows through the catalytic burner 40 and exits the catalytic burner 40 through the exhaust 38. As the air flows through the catalytic burner 40 it transfers heat to the catalytic burner 40 and the catalyst, raising the temperature of the catalytic burner 40 and the catalyst to at least the initiation temperature pre-heating the catalytic burner 40. Once the catalytic burner 40 and the catalyst are at least at the initiation temperature, the air flow is reduced and fuel mixture is provided to the catalytic burner 40.

In an alternative arrangement or as an additional feature, there may be a heater at an inlet region of the coil of the catalytic burner 40. Such a heater can be used for pre-heating fluids entering the catalytic burner, e.g. for pre-heating of fuel to aid initiation of the catalytic burning process in downstream parts of the catalytic burner. This can augment the pre-heating described above, or it may allow it to be avoided. The heater may comprise an electrical heating element and/or a heat exchanger for receiving heat via a heat exchange fluid that is heated elsewhere. The heat exchange fluid for the heater may be heated by waste heat from the fuel cell 22. The heater may take the form of a mesh extending over the cross-section of the coil at the inlet region of the catalytic burner 40.

During operation of the system, a fuel mixture comprising hydrogen and oxygen is introduced into the catalytic burner 40 via the fuel inlet 34. The catalytic burner 40 is at an elevated temperature because of the pre-heating operation. The fuel mixture travels through the pipe of the catalytic burner 40 and contacts a catalyst inside the catalytic burner 40. The fuel mixture undergoes catalytic combustion inside the catalytic burner 40 releasing heat.

The products of the catalytic combustion travel through the catalytic burner 40 to the exhaust 38 and are expelled from the catalytic burner 40 and the system. The products of the catalytic combustion travel through the whole coil of the catalytic burner 40. The heat released from the catalytic combustion is transferred from the catalytic burner 40 to the heat transfer medium raising the temperature of the heat transfer medium. The coil is configured to capture as much heat from the products of the catalytic combustion as possible, such that the products of the catalytic combustion expelled through the exhaust 38 are at a relatively low temperature. The heat transfer medium (e.g. water, glycol, a mixture of the two, or another suitable fluid) is introduced to the system through the medium inlet/outlet 36. After the temperature of the heat transfer medium is raised, the heat transfer medium is then removed from the system via the medium inlet/outlet 36. The medium inlet/outlet 36 is a thermostatic mixing valve in some applications.

FIG. 4 shows an exploded view of the system of FIG. 2 and shows components of the vessel 32. The vessel 32 comprises an inner shell 44, a support material 46 and an outer shell 48. The inner shell 44 defines the volume within which the heat transfer medium such as water is stored. The inner shell 44 is surrounded by the support material 46, which in turn supports the outer shell 48 surrounding the inner shell 44 and the support material 46. The space between the inner shell 44 and the outer shell 48 defines a volume within which the support material 46 is disposed and within which vacuum is formed. The support material 46 prevents the outer shell 48 from coming in direct contact with the inner shell 44. The vessel 32 of FIGS. 3 and 4 is provided with an outer skin 50, which protects the outer shell 48 from damage. For example, the outer skin 50 is made from neoprene and provides protection to the outer shell 48 from mechanical and chemical damage. The outer skin is also made from thermally insulating material(s), and thus provides another layer of insulation between the heat transfer medium and the environment surrounding the system.

During operation of the system, the inner shell 44 and the outer shell 48 define a volume therebetween to which a vacuum is applied. The vacuum reduces the amount of heat transferred between the inner shell 44 and the outer shell 48, which reduces the amount of heat transferred to the environment surrounding the system (e.g. ambient air). This reduction in heat transfer allows the system, and the heat transfer medium disposed within the system, to stay at an elevated temperature for longer and retain more heat energy.

Manufacturing of the system comprises forming the inner shell 44, placing the support material 46 around the inner shell 44, and placing the outer shell 48 around the inner shell 44 and the support material 46. A vacuum is then applied to the volume between the inner shell 44 and the outer shell 48. Applying vacuum to this volume removes most of the air molecules in that volume. The support material 46 is provided to retain a spacing between the inner shell 44 and the outer shell 48, preventing the outer shell 48 from contacting the inner shell 44 or deforming due to the pressure exerted by the vacuum. The support material 46 (e.g. cardboard, fibreboard, bamboo, polymer etc.) has a low heat transfer coefficient to decrease the amount of het transferred between the inner shell 44 and the outer shell 48 through the support material 46. The inner shell 44 and the outer shell 48 are made out of metal.

FIGS. 3 and 4 also show a heater 52 disposed within the volume of the vessel 32 and within the volume of the inner shell 44. The heater 52 is placed surrounding the catalytic burner 40 and is configured to raise the temperature of the catalytic burner 40. The heater 52 is used to pre-heat the catalytic burner 40 to a catalytic initiation temperature in the absence of another pre-heating source like the fuel cell heat. The heater 52 is powered by electricity.

In a configuration different to the one shown in FIGS. 3 and 4, the heater 52 can be configured to transfer heat from the fuel cell assembly 4 to the catalytic burner 40. The heater 52 can take the form of a heat exchanger. Optionally, the heater 52 can be a hybrid heater capable of transferring heat from the fuel cell to the catalytic burner for pre-heating as well as generating heat vie electrical means to pre-heat the catalytic burner 40.

During start-up operation of the system, heat is transferred from the fuel cell assembly 4 of FIG. 2 to the catalytic burner 40. The heat is transferred using a heat exchanger located in the place of the heater 52, within the vessel 32. The transferred heat raises the temperature of the catalytic burner 40, and the associated catalyst, pre-heating the catalytic burner 40 and allowing a catalytic reaction to initiate and proceed. The heat exchanger can also be used to recover heat from the fuel cell to improve the efficiency of the catalytic burner 40.

FIG. 5 shows a catalytic mesh 54 used in the catalytic combustion of the fuel mixture. The catalytic mesh 54 is disposed inside the tube of the catalytic burner 40. The catalytic mesh 54 takes the form of a long thin perforated strip wound into a helical shape. The helical shape of the catalytic mesh 54 allows it to be disposed in the pipe of the catalytic burner 40. The surface of the catalytic mesh 54 is provided with a catalyst. The catalyst is a carbon supported Platinum (Pt), Palladium (Pd) and/or Rhodium (Rh).

FIG. 6 shows a cross-section of a section of the catalytic burner 40 with the catalytic mesh 54 of FIG. 5. The catalytic burner 40 comprises a pipe 58 and a catalytic mesh 54. The catalytic mesh 54, in the form of a helix is disposed within the pipe 58 of the catalytic burner 40. The catalytic mesh 54 of FIG. 6 is the catalytic mesh 54 described in relation to FIG. 5.

During operation of the catalytic burner 40, fuel mixture travels through the interior of the pipe 58 and comes in contact with the catalytic mesh 54. Some of the fuel mixture in contact with the catalytic mesh 54 undergoes catalytic combustion releasing heat. The heat is transferred to the pipe 58 of the catalytic burner 40, and subsequently to a heat transfer medium in contact with the outside of the catalytic burner 40 pipe 58.

FIG. 7 shows an alternative configuration to the catalytic burner 40 of FIGS. 3 and 4, where the catalytic mesh 54 is removed from the catalytic burner 40, and where a surface catalyst 66 is provided inside of the catalytic burner 40. The catalytic burner 62 comprises a pipe 64 and the surface catalyst 66. The surface catalyst 66 is provided on the inner surface of the pipe 64. The surface catalyst 66 is configured to allow a catalytic reaction of the fuel mixture. It is contemplated that a catalytic burner 40 as described above comprises the catalytic mesh 54 of FIG. 6 and the surface catalyst 66 of FIG. 7 concurrently.

During operation of the catalytic burner 62, fuel mixture travels through the interior of the pipe 64 and comes in contact with the surface catalyst 66. Some of the fuel mixture in contact with the surface catalyst 66 undergoes catalytic combustion releasing heat. The heat is transferred to the pipe 64 of the catalytic burner 62 and subsequently to a heat transfer medium in contact with the outside of the catalytic burner 62 pipe 64.

FIG. 8 shows a diagram of a first deep dished end 70 and a second deep dished end 72. The first deep dished end 70 comprises a crown 74, a knuckle 76 and a straight flange 78. The knuckle 76 defines the section of the first deep dished end 70 between the crown 74 and the straight flange 78. In deep dished ends the straight flange 78 has a longer length compared to typical dished ends, such that joining the first deep dished end 70 and the second deep dished end 72 defines a vessel. The length of the straight flange 78 is therefore approximately half of the length of the vessel to be constructed. For example, a vessel with a length of 4 meters is formed by producing two deep dished ends with a straight flange length of approximately 2 meters (ignoring the height for the knuckle and the crown for simplicity).

In the deep dished ends of FIG. 8, the knuckle 76 has a smaller radius of curvature than the crown 74, however, it is possible to form deep dished ends where the knuckle 76 has a larger radius of curvature than the crown 74, and alternatively where one or both of the knuckle 76 and the crown 74 are not curved/circular in nature. For example, a deep dished end can be formed comprising a straight flange 78 and a conical end.

1. An energy generation system comprising:
a catalytic burner for producing heat energy;
an insulated vessel, wherein the insulated vessel surrounds the catalytic burner; and
a fuel cell, wherein waste heat from the fuel cell can be provided to the catalytic burner and/or to the insulated vessel;
wherein the catalytic burner includes a catalytic coil comprising a coil-shaped fluid flow path for flow of a fuel mixture and a catalytic surface extending along at least a part of the coil-shaped fluid flow path.

2. An energy generation system according to claim 1, wherein:
the fuel cell comprises a battery configured to store electrical energy generated by the fuel cell; and
the battery comprises an integrated battery integrated in a fuel cell assembly with the fuel cell and/or the battery comprises a standalone battery connected to the fuel cell.

3. An energy generation system according to claim 1, comprising a heat transfer means configured to transfer heat from the fuel cell to the catalytic burner, wherein the heat transfer means comprises at least one of:
a fuel cell heat exchanger configured to transfer heat from the fuel cell to a cooling medium;
a catalyst heating heat transfer means configured to transfer heat from the fuel cell to the inside of the catalytic burner;
a fuel heating heat transfer means configured to transfer heat from the fuel cell to a fuel mixture of the catalytic burner; and/or a heat recovery heat transfer means configured to transfer heat from the fuel cell to the catalytic burner.

4. (canceled)

5. An energy generation system according to claim 3, wherein the catalyst heating heat transfer means comprises:
the fuel cell heat exchanger;
a blower configured to blow the cooling medium over the fuel cell heat exchanger such that heat is transferred from the fuel cell heat exchanged to the cooling medium; and
a fluid passage configured to transfer the cooling fluid from the fuel cell heat exchanger to the catalytic burner such that heat is transferred from the cooling fluid to the catalytic burner.

6. An energy generation system according to claim 1, claim, wherein a fuel mixture provided to the catalytic burner comprises:
a hydrogen-based fluid; and
an oxygen-based fluid, wherein the fuel mixture provided to the catalytic burner is similar to the fuel mixture provided to the fuel cell.

7. (canceled)

8. An energy generation system according to claim 6, wherein the energy generation system comprises a single fuel connection configured to provide the fuel mixture to the fuel cell and the catalytic burner.

9. An energy generation system according to claim 6, wherein the insulated vessel is a vacuum insulated vessel.

10. An energy generation system comprising:
a catalytic burner for producing heat energy; and
an insulated vessel, wherein the insulated vessel surrounds the catalytic burner and the insulated vessel is a vacuum insulated vessel,
wherein the catalytic burner includes a catalytic coil comprising a coil-shaped fluid flow path for flow of a fuel mixture and a catalytic surface extending along at least a part of the coil-shaped fluid flow path.

11. (canceled)

12. An energy generation system according to claim 10, wherein:
the catalytic burner comprises a catalyst; and
the catalyst is in the form of a catalytic material provided on a surface configured to produce a catalytic reaction in the catalytic burner.

13. (canceled)

14. An energy generation system according to claim 10, comprising:
a catalytic mesh, wherein the catalytic mesh comprises a strip formed into a helical or a spring shape and the catalyst is disposed on the surface of the catalytic mesh.

15. An energy generation system according to claim 10, comprising:
a surface catalyst, wherein the surface catalyst is disposed on the interior surface of the catalytic burner and the catalyst is disposed on the surface catalyst.

16. An energy generation system according to claim 10, comprising:
a fuel inlet fluidly connected to the catalytic burner; and/or
an exhaust fluidly connected to the catalytic burner configured to discharge products of catalytic combustion outside of the energy generation system.

17. An energy generation system according to claim 10, wherein the insulated vessel comprises:
an inner shell;
an outer shell, wherein the outer shell is disposed around the inner shell; and
a support; wherein the support is disposed between the inner shell and the outer shell.

18. An energy generation system of claim 17, wherein the insulated vessel comprises a volume between the inner shell and the outer shell and wherein vacuum is applied to the volume to provide the vacuum insulation.

19. An energy generation system according to claim 18, wherein the support comprises a cellulose fiber.

20. An energy generation system according to claim 10, wherein the insulated vessel comprises a liquid heat transfer medium,
wherein the heat transfer medium is configured to receive the heat produced by the catalytic burner, and
wherein the heat transfer medium comprises at least one of: water, glycol, ethylene glycol, ethanol, propylene glycol or a mixture thereof.

21. (canceled)

22. An energy generation system according to claim 20, wherein the insulated vessel comprises a medium inlet and/or a medium outlet configured to permit the heat transfer medium to enter and exit from the insulated vessel.

23. An energy generation system according to claim 17, wherein the insulated vessel comprises a shell manufactured from two deep dished ends, wherein the two deep dished ends are joined together.

24. (canceled)

25. (canceled)

26. An energy generation system according to claim 9, wherein:
the catalytic burner comprises a catalyst; and
the catalyst is in the form of a catalytic material provided on a surface configured to produce a catalytic reaction in the catalytic burner.

27. An energy generation system according to claim 9, wherein the insulated vessel comprises:
an inner shell;
an outer shell, wherein the outer shell is disposed around the inner shell; and
a support; wherein the support is disposed between the inner shell and the outer shell.
